(19) United States
(12) Patent Application Publication
(10) Pub. No.: US 2005/0047754 A1
(43) Pub. Date: Mar. 3, 2005

(54) Interactive data processing method and apparatus

(75) Inventors: Kil-soo Jung, Gyeonggi-do (KR); Sung-wook Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/917,333

(22) Filed: Aug. 13, 2004

(30) Foreign Application Priority Data
Aug. 26, 2003 (KR) 2003-59097

(51) Int. Cl. H04N 5/781

(52) U.S. Cl. 386/95; 386/125

(57) ABSTRACT

A method and apparatus processing interactive data in processing information, and an information storage medium containing reference information of the interactive data, the information storage medium includes: audio/video (AV) data, and reference information on interactive data corresponding to the AV data. The reference information is stored to correspond to the AV data. According to the method and apparatus, when trick play commands and chapter switch of motion pictures are performed by a user selection in interactive mode, interactive contents being reproduced together with the moving pictures can be smoothly processed and reproduced.

### CROSS-REFERENCE RELATED APPLICATION

This application claims the priority of Korean Patent Application No. 2003-59097, filed on Aug. 26, 2003, in the Korean Intellectual Property Office, the disclosure of which is incorporated herein by reference.

### BACKGROUND OF THE INVENTION

1. Field of the Invention

The present invention relates to information processing, and more particularly, to a method and apparatus processing interactive data corresponding to moving pictures currently being reproduced, and an information storage medium storing reference information of the interactive data.

2. Description of the Related Art

FIG. 1 is a diagram showing a DVD video and corresponding displayed interactive data.

Referring to FIG. 1, when an audio/video (AV) stream is reproduced and displayed on a screen as moving pictures, interactive data of the moving pictures may be displayed together. Interactive data may be a variety of information items, such as detailed information on actors, scenes, and synopsis. Interactive data may be stored in the form of a markup document such that more information can be shown according to a user's selection. When interactive data is collected, it is referred to as interactive contents, and in an interactive mode, these interactive contents are displayed together with moving pictures.

When in the interactive mode, moving pictures are reproduced at a normal speed and a trick play command related to a reproduction speed such as fast forward play or fast rewind play of the moving pictures is performed by a user's selection, or chapter change is performed, and a problem how interactive contents are to be displayed together with the moving pictures on the screen arises.

That is, if while moving pictures are reproduced at a fast speed, all the related interactive contents are to be shown, the workload of the reproduction apparatus will be too heavy, and even if all interactive contents are shown, too much information is displayed such that the user cannot use this information.

### SUMMARY OF THE INVENTION

The present invention provides a method and apparatus processing interactive data reproduced together with moving pictures when trick play commands or chapter change of moving pictures are performed by a user's selection, and an information storage medium storing reference information of interactive data.

According to an aspect of the present invention, there is provided an information storage medium including: audio/video (AV) data; and reference information on interactive data corresponding to the AV data, wherein the reference information is stored to correspond to the AV data.

According to another aspect of the present invention, the reference information may be stored to correspond to the AV data with respect to reproduction units dividing the AV data.

According to another aspect of the present invention, the reference information may also be stored to correspond to the AV data with respect to reproduction elapsed time of the AV data.

According to another aspect of the present invention, there is provided an information storage medium including: AV data; and interactive data which is displayed together with the AV data, and includes the current reproduction state and content information of the AV moving pictures to be displayed if a command related to the reproduction speed of the AV data is received.

According to still another aspect of the present invention, there is provided an interactive data processing method including: receiving a command to change the location of reproduction of moving pictures being reproduced; according to the command, changing the location of reproduction, performing reproduction, and receiving reproduction unit information of moving pictures being reproduced; and according to the received reproduction unit information, displaying interactive data corresponding to the moving pictures.

According to yet still another aspect of the present invention, there is provided an interactive data processing method including: receiving a command related to reproduction speed such as fast forward play or rewind of moving pictures; and performing the command and displaying the current reproduction state and content information of the moving pictures.

According to a further aspect of the present invention, there is provided an interactive data processing apparatus including: a moving picture reproduction unit which receives a command to change the location of reproduction of moving pictures being reproduced, changes the location of reproduction of the moving pictures, and reproduces the moving pictures; a reproduction unit information reception unit which receives reproduction unit information of the moving pictures being reproduced; and a presentation engine unit which according to the received reproduction unit information, reproduces interactive contents corresponding to the moving pictures.

According to another aspect of the invention, there is provided a computer readable medium encoded with processing instructions performing an interactive data processing method, the method including: receiving a command to change a location of reproduction of moving pictures being reproduced; changing the location of reproduction according to the received command, performing reproduction, and receiving reproduction unit information of the moving pictures being reproduced; and displaying interactive data corresponding to the moving pictures according to the received reproduction unit information of the moving pictures.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram showing a DVD video and corresponding displayed interactive data;

FIGS. 2A through 2C are tables storing reference information of interactive contents;

FIG. 3 is a diagram showing a display screen when a trick play command is performed;

FIG. 4 is a flowchart of the operations performed by an embodiment of a method of processing interactive data according to the present invention;

FIG. 5 is a flowchart of the operations performed by an embodiment of a method of processing a command related to a reproduction speed; and

FIG. 6 is a block diagram of an apparatus processing interactive data according to the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

While an AV reproduction apparatus of the present invention reproduces moving pictures in an interactive mode, if a user inputs a command for chapter change of moving pictures currently being reproduced, the AV reproduction apparatus receives chapter information through an application program interface (API) event at that moment. Also, the AV reproduction apparatus may operate in another method in which, if the user inputs a chapter change command while moving pictures are reproduced in an interactive mode, then, if a chapter change command of the moving pictures currently being reproduced from the user is received, the AV reproduction apparatus performs this command and by generating “chapter_Number” API property that is to obtain the number of a chapter currently being reproduced, receives chapter information.

Then, by reading a file including information on the chapter or the elapsed time of moving pictures, the AV reproduction apparatus displays interactive contents corresponding to the current chapter number.

Next, if a trick play command from the user, such as fast forward play or rewind of moving pictures currently being reproduced is received while moving pictures are reproduced in the interactive mode, the trick play command is performed. While the trick play command is performed, information explaining the trick play command currently being performed is displayed on the screen as well.

Then, if a normal reproduction command is received again, information on the elapsed time of the moving pictures currently being displayed is received through an API event. Also, the AV reproduction apparatus may operate in another method in which if a normal reproduction command is received, this normal play command is performed, and by generating “elapsed_Time” API property, information on the reproduction elapsed time is received. Then, a file including information on the elapsed time of the moving pictures or the chapter is read and interactive contents corresponding to this elapsed time are displayed.

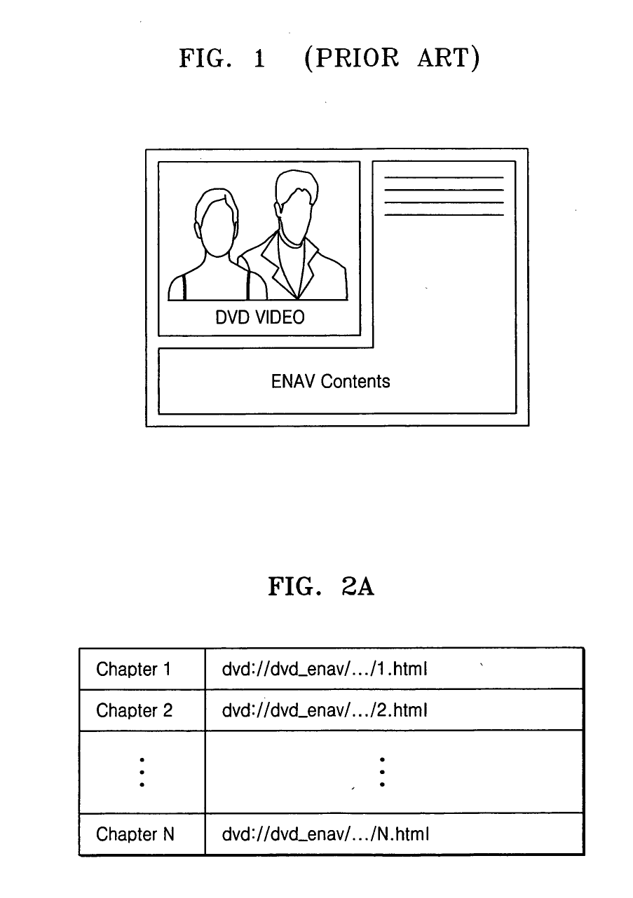

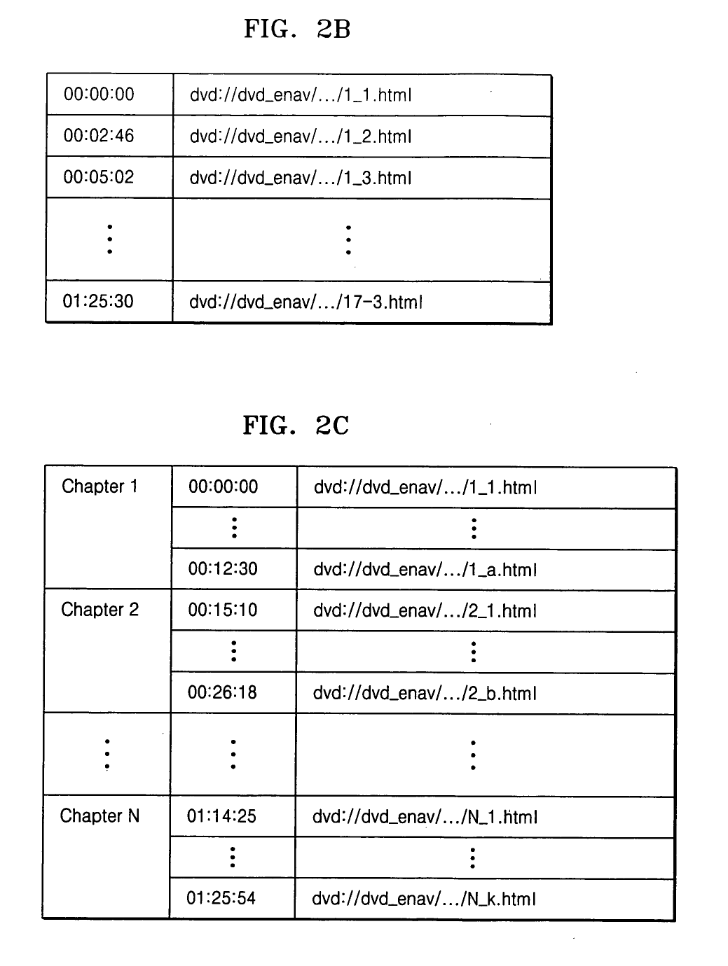

FIGS. 2A through 2C are tables storing reference information of interactive contents.

Referring to FIG. 2A, reference information may be stored to correspond to chapter information. Referring to FIG. 2B, this reference information may be stored to correspond to a reproduction elapsed time, that is time elapse information on the entire reproduction time of the moving pictures. Referring to FIG. 2C, this reference information may be stored to correspond to both chapter information and a reproduction elapsed time. This reference information can be stored by the following two methods.

In the first method, the information tables shown in FIGS. 2A through 2C are included in a text file or a binary file related to startup that is first read when an information storage medium having interactive contents is placed into a reproduction apparatus. When the information storage medium is placed into the reproduction apparatus, the information table as described above is loaded in a memory in advance as one of the information items initially required. By doing so, when in the interactive mode, a normal reproduction state is returned after a trick play command of moving pictures or chapter change, interactive contents matching the moving pictures are displayed on the screen using the information table.

In the other method, chapter information or the elapsed time information in the entire time of the moving pictures is included in respective markup documents displayed together with moving pictures, or in a document performing such functions. For example, when interactive contents are expressed in a markup document, chapter information or the elapsed time information in the entire time of the moving pictures can be expressed by using <meta> elements, as follows:

<html>
<head>
<title>Example</title>
<meta name=“chapter” content=“1” />
<meta name=“elapsed time” content=“00:32:20, 00:39:12” />
</head>
<body>
. . .
</body>
</html>

According to the methods described above, information on the interactive contents file that should be displayed according to chapter information or the elapsed time of the entire pictures can be recorded.

Meanwhile, while moving pictures are reproduced in the interactive mode, if the user inputs a command to change moving pictures to the next chapter or the previous chapter, the presentation engine sends an API corresponding to the command to the moving picture reproduction engine, because the control over all contents is held by the presentation engine in the interactive mode. Then, the moving picture reproduction engine performs navigation to the next chapter or the previous chapter, and receives from the presentation engine, the chapter number of the moving pictures that are reproduced after the user input, through an API property such as “chapter_Number”, or receives the same through an API event. Then, using one of the two methods described above, interactive contents are displayed together with corresponding moving pictures.

Meanwhile, while the user watches moving pictures in normal reproduction state in the interactive mode, if a trick play command such as fast forward play or rewind of moving pictures is to be performed, the presentation engine sends an API property such as “elapsed_Time” to the moving picture reproduction engine at a regular time interval such that reproduction elapsed time information is received. The reproduction elapsed time information can also be received through an API event.

Then, by using one of the two methods described above, interactive contents are displayed after synchronization.

Also, when a trick play command is performed by a user selection, the presentation engine sends an API corresponding to the command, to the moving picture reproduction engine, and at the same time, replacement interactive contents embedded in the memory of the reproduction apparatus or manufactured directly by a contents producer are displayed on the screen.

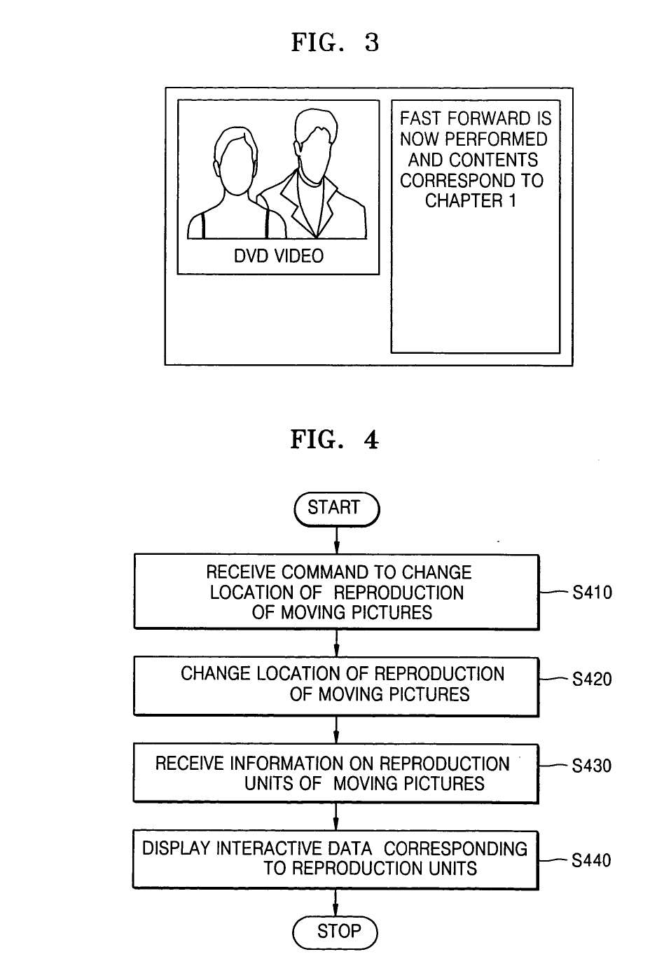

FIG. 3 is a diagram showing a display screen when a trick play command is performed.

As shown in FIG. 3, when a trick play command is performed in the interactive mode, a replacement page that includes only brief information in the form of an ordinary markup document is provided, or without displaying an interactive screen in addition to moving pictures, current reproduction information is briefly displayed on an on screen display (OSD) screen. During the trick play command, if a user's input requesting normal reproduction in a predetermined screen is received, the presentation engine sends an API corresponding to the input, to the moving picture reproduction engine such that normal reproduction can be performed. Then, through an API property such as “elapsed_Time”, the elapsed time information corresponding to the current location of the moving pictures is received, and by using one of the two methods described above, interactive contents that should be displayed together with the corresponding moving pictures are reproduced.

In addition to this method, when a user input corresponding to a trick play command is received in the interactive mode, the reproduction apparatus may send an error message or a warning message such as “UOP_NOT_ALLOWED”, and not perform the received trick play command.

FIG. 4 is a flowchart of the operations performed by an embodiment of a method processing interactive data according to the present invention.

If a command to change the reproduction location of moving pictures being reproduced is received in operation S410, according to the command, the reproduction location of the moving pictures is changed and the moving pictures are reproduced in operation S420. Reproduction unit information may be information on reproduction units dividing the moving pictures or information on the reproduction time of the moving pictures. Then, reproduction unit information of the moving pictures being reproduced is received in operation S430. The reproduction location of the moving pictures is changed and the moving pictures are reproduced, and receiving the reproduction unit information of the moving pictures being reproduced is performed using an API command. Then, according to the received reproduction unit information, interactive data corresponding to the moving pictures is displayed in operation S440.

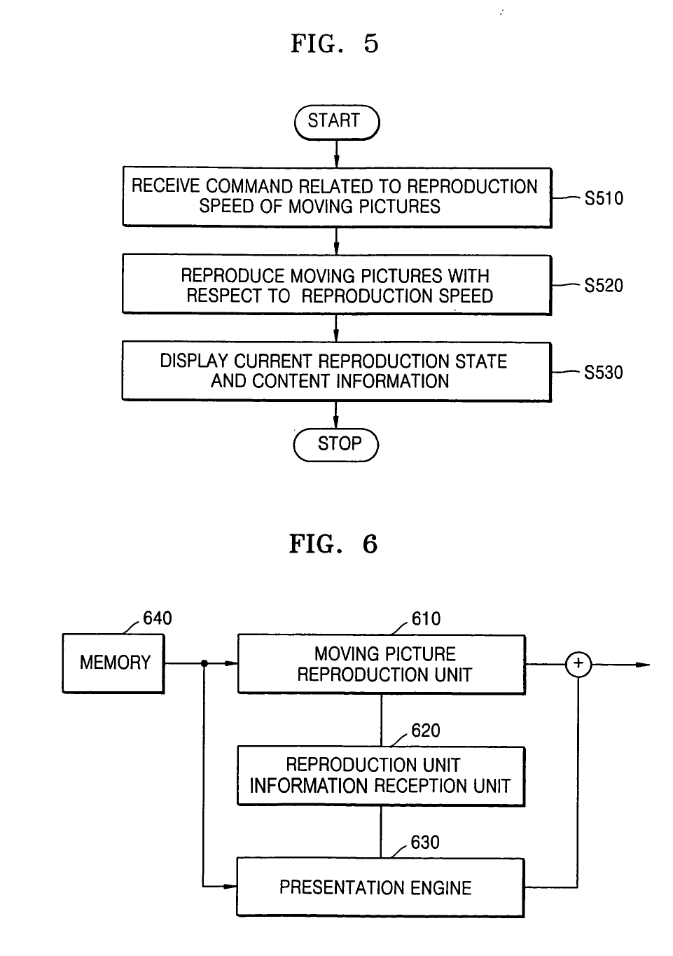

FIG. 5 is a flowchart of the operations performed by an embodiment of a method processing a command related to a reproduction speed.

A command related to reproduction speed such as fast forward play or rewind of the moving pictures is received in operation S510. According to the received command, moving pictures are reproduced in operation S520 and the current reproduction state and content information of the moving pictures are displayed in operation S530. At this time, the current reproduction state and content information of the moving pictures can be stored in an information storage medium storing the moving pictures or inside the reproduction apparatus of the information storage medium.

FIG. 6 is a block diagram of an apparatus processing interactive data according to an embodiment of the present invention.

The interactive data processing apparatus includes a moving picture reproduction unit 610, a reproduction unit information reception unit 620, a presentation engine 630, and a memory 640. The moving picture reproduction unit 610 receives a command to change the reproduction location of moving pictures being reproduced, changes the reproduction location of the moving pictures, and reproduces the moving pictures. At this time, an API command can be used so that the reproduction location of the moving pictures is changed and the moving pictures are reproduced. If a command related to reproduction speed such as fast forward play or rewind of the moving pictures is received, fast forward play or rewind of the moving pictures is performed.

The reproduction unit information reception unit 620 receives the reproduction unit information of the moving pictures being reproduced. Then, according to the characteristics of the moving pictures, information on reproduction units dividing the moving pictures or information on the reproduction time of the moving pictures is received. Also, receiving the reproduction unit information of the moving pictures being reproduced can be performed using an API command. The current reproduction state and content information of the moving picture may be included in a markup document inside the interactive contents, or in the form of graphic data.

The presentation engine 630 reproduces interactive contents corresponding to the moving pictures according to the received reproduction unit information. The interactive contents are produced by referring to information on reproduction units dividing the moving pictures or information on the reproduction time of the moving pictures. The memory 640 stores moving pictures and interactive contents.

The aforementioned interactive data processing method may be embodied as a computer program that can be run by a computer, which can be a general or special purpose computer. Thus, it is understood that the apparatus of the present invention can be such a computer. Computer programmers in the art can easily reason codes and code segments, which constitute the computer program. The program is stored in a computer readable medium readable by the computer. When the program is read and run by a computer, the interactive data processing method is performed. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The embodiments should be considered in descriptive sense only and not for purposes of limitation. Therefore, the scope of the invention is defined not by the detailed description of the invention but by the appended claims, and all differences within the scope will be construed as being included in the present invention.

According to the present invention as described above, when trick play commands and chapter switch of motion pictures are performed by a user selection in the interactive mode, interactive contents being reproduced together with the moving pictures can be smoothly processed and reproduced.

1. An information storage medium comprising:
audio/video (AV) data; and
reference information of interactive data corresponding to the AV data, wherein the reference information is stored to correspond to the AV data.

2. The information storage medium of claim 1, wherein the reference information is stored to correspond to the AV data with respect to reproduction units dividing the AV data.

3. The information storage medium of claim 2, wherein the reproduction units are chapters of the AV data.

4. The information storage medium of claim 1, wherein the reference information is stored to correspond to the AV data with respect to reproduction elapsed time of the AV data.

5. The information storage medium of claim 1, wherein the reference information is stored in the form of a text file or a binary file.

6. The information storage medium of claim 1, wherein the reference information is included in a markup document storing detailed information on the AV data.

7. An information storage medium comprising:
audio/video (AV) data; and
interactive data which is displayed together with the AV data, and includes a current reproduction state and content information of AV moving pictures to be displayed if a command related to a reproduction speed of the AV data is received.

8. An interactive data processing method comprising:
receiving a command to change a location of reproduction of moving pictures being reproduced;
changing the location of reproduction according to the received command,
performing reproduction, and receiving reproduction unit information of the moving pictures being reproduced; and
displaying interactive data corresponding to the moving pictures according to the received reproduction unit information of the moving pictures.

9. The method of claim 8, wherein the received reproduction unit information is information on a reproduction unit dividing the moving pictures or information on a reproduction time of the moving pictures.

10. The method of claim 8, wherein the changing of the location of the reproduction, the performing of the reproduction, and the receiving of the reproduction unit information of the moving pictures being reproduced is performed using an application program interface (API) command.

11. An interactive data processing method comprising:
receiving a command related to reproduction speed of moving pictures; and
performing the command and displaying a current reproduction state and content information of the moving pictures.

12. The method of claim 11, wherein the current reproduction state and content information of the moving pictures are stored in advance in an information storage medium storing the moving pictures, or inside a reproduction apparatus of the information storage medium.

13. An interactive data processing apparatus comprising:
a moving picture reproduction unit which receives a command to change a location of reproduction of moving pictures being reproduced, changes the location of the reproduction of the moving pictures, and reproduces the moving pictures;
a reproduction unit information reception unit which receives reproduction unit information of the moving pictures being reproduced; and
a presentation engine unit which according to the received reproduction unit information, reproduces interactive contents corresponding to the moving pictures.

14. The apparatus of claim 13, further comprising: a memory which stores the moving pictures and the interactive contents.

15. The apparatus of claim 13, wherein according to characteristics of the moving pictures, the reproduction unit information reception unit receives the reproduction unit information dividing the moving pictures, or information on elapsed reproduction time of the moving pictures.

16. The apparatus of claim 13, wherein the moving picture reproduction unit changes the location of the reproduction of the moving pictures and reproduces the moving pictures using an API command, and the reproduction unit information reception unit receives the reproduction unit information of the moving pictures being reproduced, using the API command.

17. The apparatus of claim 13, wherein if a command related to reproduction speed of the moving pictures is received, the moving picture reproduction unit performs the command, and an interactive contents reproduction unit displays a current reproduction state and content information of the moving pictures.

18. The apparatus of claim 17, wherein the current reproduction state and the content information of the moving pictures are included in a markup document inside the interactive contents, or in a form of graphic data.

19. The apparatus of claim 13, wherein if a normal speed reproduction command of the moving pictures is input to the moving picture reproduction unit, the moving picture reproduction unit performs the normal speed reproduction command, and an interactive contents reproduction unit receives current reproduction elapsed time information of the moving pictures and displays the interactive contents of a time corresponding to the information.

20. The apparatus of claim 19, wherein the interactive contents are produced by referring to information on reproduction units dividing the moving pictures according to the characteristics of the moving pictures, or information on the reproduction elapsed time of the moving pictures.

21. A computer readable medium encoded with processing instructions performing an interactive data processing method, the method comprising:
receiving a command to change a location of reproduction of moving pictures being reproduced;
changing the location of reproduction according to the received command;
performing reproduction;
receiving reproduction unit information of the moving pictures being reproduced; and
displaying interactive data corresponding to the moving pictures according to the received reproduction unit information of the moving pictures.

22. The method of claim 21, wherein the received reproduction unit information is information on a reproduction unit dividing the moving pictures or information on a reproduction time of the moving pictures.

23. The method of claim 21, wherein the changing of the location of the reproduction, the performing the reproduction, and the receiving of the reproduction unit information of the moving pictures being reproduced is performed using an application program interface (API) command.

24. The information storage medium of claim 1, wherein when the information storage medium is placed in a reproduction apparatus, the reference information is loaded in a memory in advance as an information item initially required.

25. The information storage medium of claim 7, wherein chapter information or elapsed time information of an entire time of the AV moving pictures is included in markup documents displayed together with the AV moving pictures.

26. The interactive data processing apparatus of claim 13, wherein while the moving pictures are reproduced, if a user inputs a command to change the moving pictures to a next chapter or a previous chapter, the presentation engine sends an application program interface (API) command corresponding to the input command to the moving picture reproduction engine.
